(19) United States
(12) Patent Application Publication
(10) Pub. No.: US 2020/0356077 A1
(43) Pub. Date: Nov. 12, 2020

(54) CUTTING TOOL WHICH IS ASSEMBLED AND READY FOR DELIVERY

(71) Applicant: CERATIZIT AUSTRIA GESELLSCHAFT M.B.H., Reutte (AT)

(72) Inventor: ALEXANDER SINGER-SCHNOELLER, REUTTE (AT)

(21) Appl. No.: 16/764,501

(22) PCT Filed: Nov. 13, 2018
(86) PCT No.: PCT/AT2018/060268

§ 371 Date: May 15, 2020

(30) Foreign Application Priority Data
Nov. 15, 2017 (AT) GM 50206/2017

(51) Int. Cl. G05B 19/4155; B23B 27/16; B23B 49/00

(52) U.S. Cl. CPC G05B 19/4155; B23B 27/16; G05B 2219/37355; B23B 2200/36; B23B 2200/0447; B23B 49/00

(57) ABSTRACT

A cutting tool that is assembled and ready for delivery has at least one actual dimension relating to a physical configuration of the cutting tool and being relevant for a cutting process carried out by the cutting tool. The cutting tool that is assembled and ready for delivery is assigned at least one information source that is readable by a user or a data processing system. The information source provides or encodes information relating to a deviation of the at least one actual dimension from a target dimension or the actual dimension itself. A holder for a cutting tool and a machine tool having a cutting tool are also provided.

The invention relates to a cutting tool which is assembled and ready for delivery, having the features of the preamble of claim 1, to a holder for such a cutting tool having the features of claim 10, and to a machine tool having the features of the preamble of claim 11.

The continuously increasing demands made of machine tools with cutting tools which can be detachably fastened to holders have the effect, with respect to tolerances or positioning accuracy of the cutting edge of the cutting tools, that design according to a standard (DIN-ISO) is in some cases no longer sufficient, and stricter requirements are being made by manufacturer specifications.

When machine tools which are designed as milling machines are equipped with cutting tools, in particular the axial run-out property of the individual cutting edges with respect to one another in the machine tool is defined as an important feature. When machine tools which are embodied as turning machines are equipped, it is better to speak of repetition accuracy, since variation is observed here when the cutting tool is exchanged on the holder.

The prior art has already disclosed a large number of devices which have the objective of improving the positioning accuracy of cutting tools in turning tools or milling tools. Reference is made by way of example to WO 87/01319 A1, GB 2 496 510 A, WO 02/04157 A1 and DE 198 27 778 A1.

The target dimension of a cutting tool can relate, for example, to a specific distance of a cutting edge of the cutting tool from a reference point, for example a center point or some other predefined point on the cutting tool.

In order to achieve the necessary positioning accuracy of the cutting tool on the holder, it is not possible for a user of the clamping tool to refer to the target dimension of the cutting tool, since owing to fabrication tolerances there may be deviations of the actual dimension from the target dimension.

A disadvantage in the prior art is the fact that the actual dimension which is present in relation to a physical configuration of the cutting tool and is relevant for the cutting process which is planned or is carried out has to be determined by a user of the cutting tool himself by one or more measurements, which is time-consuming and susceptible to faults. The necessary positioning accuracy of the cutting edge of the cutting tool on a holder can therefore be carried out only very laboriously or not at all.

Although the manufacturers of cutting tools usually determine the actual dimension of each cutting tool within the scope of quality assurance, this information is lost, since the only checking carried out is to determine whether each cutting tool has an actual dimension which lies within a predefined deviation window in relation to a predefined target dimension, and those cutting tools which are not within the deviation window are eliminated. In the prior art, the only information about the cutting tools which are assembled and ready for use is that their actual dimensions are present in a deviation window which is in any case unknown to the user.

DE 10 2005 015 930 A1 teaches a cutting tool which can be adjusted in order to compensate for wear, wherein in order to perform the adjustment an adjustment screw with a setting aid such as a scale is provided. The cutting tool which is assembled and ready for use does not have any information whatsoever about its actual dimension.

The object of the invention is to provide a cutting tool of the generic type, a holder of the generic type and a machine tool of the generic type with which a high level of positioning accuracy of the cutting edge of the cutting tool on a holder can be achieved more quickly and with less susceptibility to faults than in the prior art.

This object is achieved by means of a cutting tool which is assembled and ready for delivery and has the features of claim 1, a holder having the features of claim 10 and a machine tool having the features of claim 11. Advantageous embodiments of the invention are defined in the dependent claims.

A cutting tool which is assembled and ready for delivery to the user (prepared for ultimate use) and has at least one actual dimension relating to a physical configuration of the cutting tool, wherein the actual dimension is relevant for a cutting process carried out by means of the cutting tool, wherein there is provided that at least one information source is assigned to the cutting tool which is assembled and ready for delivery, wherein the at least one information source can be read out by a user or a data processing system and provides or encodes information about a deviation of the at least one actual dimension from a target dimension or the actual dimension itself, has the advantage that a very high positioning accuracy of the cutting tool can be achieved without the need for measurements of the cutting tool by the user, which are time-consuming and/or susceptible to faults.

The determination of the actual dimension is preferably carried out by the manufacturer of the cutting tools immediately after their fabrication before the cutting tool which is assembled and ready for delivery leaves the factory. The assembly of the cutting tool for delivery is carried out, for example, by packing the cutting tool.

The at least one information source is preferably arranged only in a space-limited partial region of the cutting tool itself.

The at least one information source can be arranged on or in the cutting tool itself and/or on or in a packaging of the assembled cutting tool.

The at least one information source can be provided in a way which is known to a person skilled in the art depending on the type of information source, for example by lasering a region of the cutting tool itself. Ways of providing the at least one information source in which it is arranged captively on the cutting tool, such as, for example, the abovementioned lasering, are preferred.

Captive provision or marking is to be understood as a way of providing an information source or marking in which the information source is formed integrally with the cutting tool which is to be marked. Examples of processes for producing such captive provisions of information or markings are lasering, etching, needle stamping, labelling methods with permanent colors or the like.

However, there can also be provision that the at least one information source is captively assigned to the cutting tool which is assembled and ready for delivery. Captive provision of information or marking is to be understood as a way of providing information or marking in which the information source is not formed integrally with the cutting tool to be marked. Examples of methods for captively providing information or marking would be labels, stuck-on chips or the like.

The at least one information source can be embodied in the form of an alphanumeric specification and/or encoding, wherein there is preferably provided that the encoding is embodied in the form of at least one of the types described below:
barcode or QR code
symbol or symbol chain
color or color combination
morphologically in the form of a surface configuration
permanently impressed magnetic field or carrier for a transient electromagnetic field
capacitive data carrier
holographic code.

There is preferably provided that the cutting tool is embodied as an exchangeable cutting insert, preferably as an indexable insert.

There is preferably provision that the cutting tool has at least two cutting edges, and either
an information source is provided which provides or encodes, for each of the at least two cutting edges, the information regarding a deviation of the at least one actual dimension from a target dimension or the actual dimension itself, or
two information sources are provided, one information source of which, which relates to one of the at least two cutting edges, respectively providing or encoding the information about a deviation of the at least one actual dimension from a target dimension or the actual dimension itself.

The cutting tool can be designed for turning, milling or drilling.

The at least one information source can be permanently assigned to the cutting tool which is assembled and ready for delivery, or there can alternatively be provision that the at least one information source is only temporarily assigned to the cutting tool which is assembled and ready for delivery. In the latter case there can be provision that the at least one information source is arranged on the cutting tool in such a way that the at least one information source is destroyed by the correct use (at least to such a degree that the information can no longer be read by a user or a data processing system). As a result of the correct use, the actual dimension of the cutting tool changes and the information which is provided or encoded by the at least one information source is no longer applicable. The destruction of the at least one information source by the delivery prevents a user from using the information, which is no longer applicable, for positioning the cutting tool which has already been used.

Permanent provision of information or marking is to be understood as being a permanent, constant way of providing information or marking in which in the case of correct use (that is to say resistant to expected influences) the information source is retained on the cutting tool. Expected influences would be, for example, wear which occurs as a result of correct use of the cutting tool (as a result of swarf, cooling fluid and the like). In contrast to this, temporary provision of information or marking is to be understood as a way of providing information or marking in which the information source can be lost in the case of correct use.

Reading devices can be understood to be any type of device which permits the information source to be evaluated depending on the type of information source. For appropriately embodied information sources it thus is perfectly conceivable to use optical or infrared-supported reading devices or to use a barcode reader or a QR code reader. The use of RFID reading devices or magnetic information readers is also perfectly conceivable.

A holder for a cutting tool according to at least one of the discussed exemplary embodiments is preferably provided, wherein the cutting tool can be detachably fastened to the holder, and the holder has a setting device for setting a position of the cutting tool on the holder in relation to at least one direction, wherein the holder has a marking which corresponds with respect to the at least one information source of the cutting tool, the marking having the purpose of setting the position of the cutting tool on the holder depending on the information provided or encoded by the at least one information source, or a reading device for automatically reading in the information provided or encoded by the at least one information source.

A machine tool is preferably provided having a cutting tool which is embodied according to at least one of the discussed exemplary embodiments, wherein the machine tool has a reading device for automatically reading in the information provided or encoded by the at least one information source, and the machine tool is designed
to present the information provided or encoded by the at least one information source to a user in a readable fashion and/or
to automatically carrying out a setting of the cutting tool depending on the information provided or encoded by the at least one information source.

There is preferably provision here that the machine tool has a holder for a cutting tool, wherein the machine tool for the automatic setting of the cutting tool is designed to automatically activate the setting device of the holder.

Exemplary embodiments of the invention are discussed with reference to the figures, of which:

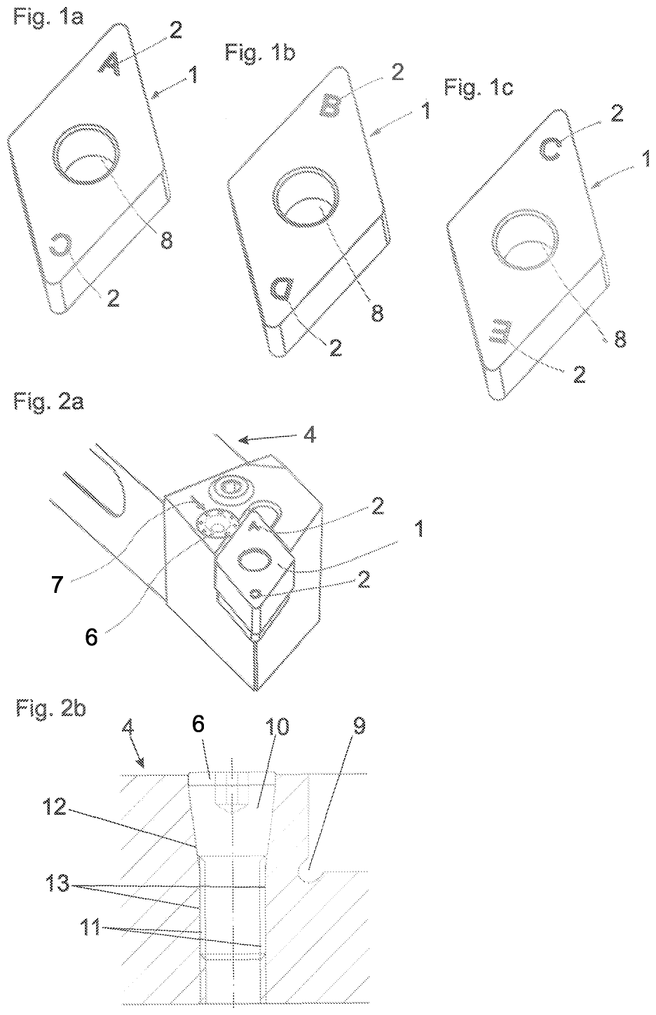

FIGS. 1a-c show exemplary embodiments of the invention for three different cutting tools in which two information sources are arranged on the cutting tool itself,

FIGS. 2a, 2b show a holder for a cutting tool together with a cutting tool and a detailed illustration relating to the setting device,

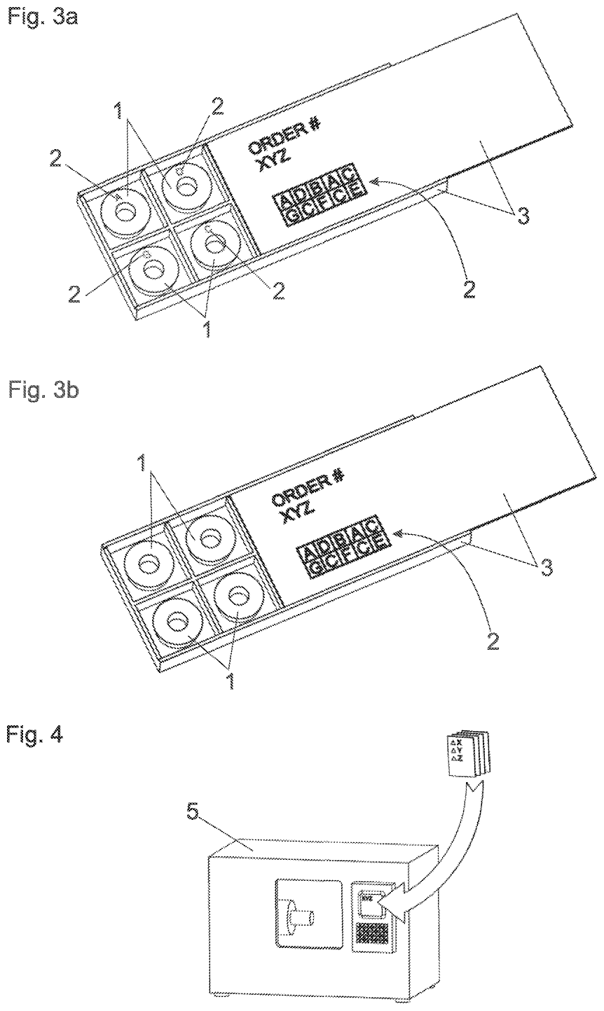

FIGS. 3a, 3b show two exemplary embodiments of the invention in which information sources for a plurality of cutting tools are arranged on packaging for cutting tools,

FIG. 4 shows an exemplary embodiment of the invention in which a machine tool automatically reads out the at least one information source, and

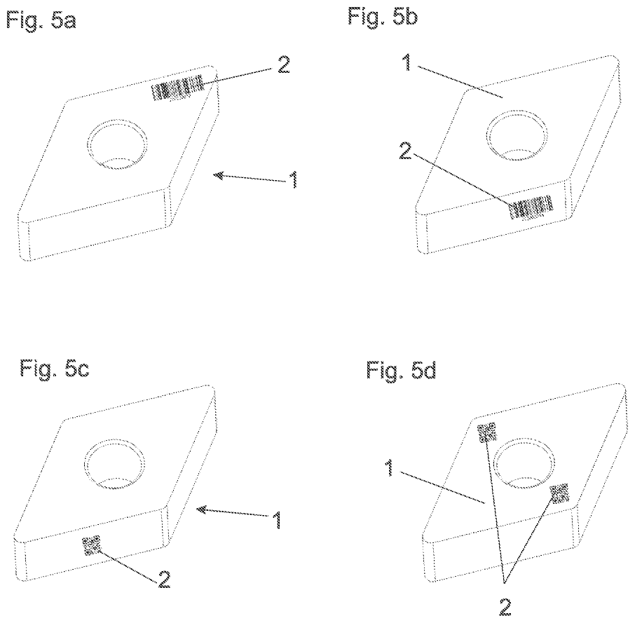

FIGS. 5a-d show further exemplary embodiments of the invention with information sources which are optimized for reading in by machine.

FIGS. 1a-c show three different cutting tools 1 in the form of indexable inserts which each have two information sources 2, wherein on each cutting tool 1 each information source 2 relates to one of the two possible installation positions (via a drilled hole 8) on a holder 4 and has an alphanumeric code A-E. A separate information source 2 is provided for each usable cutting edge of the indexable insert.

In one exemplary embodiment of the invention (FIG. 2a), the holder 4 provides, for the cutting tool 1 which is embodied here as an indexable insert, a setting device 6, which is known per se, for setting a position of the cutting tool 1 on the holder 4. Said setting device 6 can be configured in a desired direction (fine adjustment of the radial rotational axis in this case).

The setting device 6 can be designed in any known manner, e.g. the setting can be carried out by means of an eccentric or a cone. In the detailed illustration in FIG. 2b, an example is shown in which the activation is carried out by means of a rotationally symmetrical adjustment cone 10 which has a thread 11 at its lower end. The adjustment cone 10 ideally has a low pitch (e.g. 1:10) in order to achieve precise setting of the cutting tool 1 on the holder 4. The thread 11 can be embodied as a standard thread or a fine thread.

An interface (e.g. hexagonal head screw or torx) is provided on the upper section of the adjustment cone 10 for a commercially available tool for the application of the rotational movement. A matching opposing cone 12 in the form of a drill geometry and a matching opposing thread 13 (in the lower region) are arranged in the holder 4. During the turning in, the adjustment cone 10 elastically displaces a defined region of the holder 4. The defined region can be defined geometrically by grooves 9, slots or cutouts in such a way that the elastic deformation occurs in a defined direction.

Every indexable insert is provided during the final examination at the factory with an information source 2 in the form of encoding at a clearly visible point. In this exemplary embodiment, the cutting tool 1 itself has (in a captive fashion here) the information source 2 even before the cutting tool 1 is packed or assembled for delivery to the users. A separate information source 2 is preferably provided for each usable cutting edge of the indexable insert. In this exemplary embodiment, the encoding is embodied in such a way that a predefined letter A-G defines the deviation of the actual dimension of the cutting edge of the indexable insert from target dimension.

TABLE 1

| Code | Deviation in millimeters: |
|---|---|
| A | +0.03 |
| B | +0.02 |
| C | +0.01 |
| D | 0.00 |
| E | −0.01 |
| F | −0.02 |
| G | −0.03 |

The setting device 6 for setting a position of the cutting tool 1 on the holder 4 is equipped here with a corresponding encoding A-G and a marking 7 which corresponds in relation to the at least one information source 2 of the cutting tool 1. If the information source 2 of the cutting edge, to be used for the cutting process, of the cutting tool 1 exhibits for example the code “C”, the user must turn the setting device 6 (an adjustment wheel in this case) to the corresponding position “C” in relation to the marking 7, and in doing so brings about the desired precise positioning of the cutting edge of the cutting tool 1 on the holder 4 while taking into account the actual dimension of the physical configuration of the cutting tool 1. In this exemplary embodiment, the user does not need to have any knowledge at all as to how large the deviation of the actual dimension from the target dimension is for a specific code. The user brings about very precise positioning accuracy on the machine tool 5 without the user himself having to acquire the actual dimension or a deviation of the actual dimension from the target dimension.

As an alternative to the specification of a code, the information source 2 could provide the actual dimension itself or the deviation of the actual dimension from the target dimension itself. This information can be used by the user to make the necessary changes to the position of the cutting tool 1 by means of a setting device. In this case, the setting device 6 does not have to have any encoding A-G.

FIG. 3a shows an exemplary embodiment in which a plurality of cutting tools 1 are assembled in a package 3. The package 3 for each cutting tool 1 has an information source 2 which provides or encodes information about a deviation of the at least one actual dimension from a target dimension or the actual dimension itself, specifically if appropriate for each cutting edge of each cutting tool 1. Moreover, each cutting tool 1 is also provided with an information source 2, but this is not absolutely necessary, as is shown in FIG. 3b.

FIG. 4 shows a machine tool 5 with a cutting tool 1 which is embodied here as an indexable insert. The machine tool 5 has a reading device for automatically reading in the information which is provided or encoded by the information source 2.

The machine tool 5 can be designed:
to present the information provided or encoded by the information source 2 to a user in a readable fashion and/or
to automatically carrying out a setting of the cutting tool 1 depending on the information provided or encoded by the information source 2.

FIGS. 5a to 5d show further cutting tools 1 with information sources 2 which are optimized for automatically reading in, e.g. in the form of barcodes or QR codes.

### LIST OF REFERENCE NUMBERS

1 Cutting tool
2 Information source
3 Packaging of the assembled cutting tool
4 Holder for a cutting tool
5 Machine tool
6 Setting device for a cutting tool
7 Marking on holder
8 Drilled hole on cutting tool
9 Groove on holder
10 Adjustment cone
11 Thread of adjustment cone
12 Opposing cone
13 Opposing thread

1-13. (canceled)

14. A cutting tool being assembled and ready for delivery, the cutting tool comprising:
at least one actual dimension relating to a physical configuration of the cutting tool and being relevant for a cutting process carried out by the cutting tool; and
at least one information source to be read out by a user or a data processing system, said at least one information source providing or encoding information about a deviation of the at least one actual dimension from a target dimension or the actual dimension itself.

15. The cutting tool according to claim 14, wherein said at least one information source is disposed at least one of on or in the cutting tool itself or on or in packaging of the assembled cutting tool.

16. The cutting tool according to claim 14, wherein:
said at least one information source is configured as at least one of an alphanumeric specification or encoding; and
said encoding is at least one of:
a barcode or QR code.
a symbol or symbol chain,
a color or color combination,
a morphological surface configuration,
a permanently impressed magnetic field or carrier for a transient electromagnetic field.
a capacitive data carrier, or
a holographic code.

17. The cutting tool according to claim 14, wherein the cutting tool is an exchangeable cutting insert or an indexable insert.

18. The cutting tool according to claim 14, wherein the cutting tool is constructed for turning, milling or drilling.

19. The cutting tool according to claim 14, wherein said at least one information source is captively assigned to the cutting tool by lasering, etching, needle stamping or labelling with permanent colors.

20. The cutting tool according to claim 14, wherein said at least one information source is permanently assigned to the cutting tool.

21. The cutting tool according to claim 14, wherein said at least one information source is temporarily assigned to the cutting tool.

22. The cutting tool according to claim 21, wherein said at least one information source is destroyed upon delivery of the cutting tool.

23. The cutting tool according to claim 14, which further comprises:
at least two cutting edges of the cutting tool;
said at least one information source providing or encoding information regarding a deviation of the at least one actual dimension from a target dimension or the actual dimension itself for each of said at least two cutting edges, or
said at least one information source including two information sources, and each of said information sources relating to a respective one of said at least two cutting edges and providing or encoding information about a deviation of the at least one actual dimension from a target dimension or the actual dimension itself.

24. A holder for detachably fastening a cutting tool according to claim 14 to the holder, the holder comprising:
a setting device for setting a position of the cutting tool on the holder relative to at least one direction; and
a marking corresponding to said at least one information source of the cutting tool for setting a position of the cutting tool on the holder depending on information provided or encoded by said at least one information source, or
a reading device for automatically reading-in information provided or encoded by the at least one information source.

25. A machine tool, comprising:
a cutting tool according to claim 14; and
a reading device for automatically reading-in information provided or encoded by said at least one information source;
the machine tool configured to at least one of:
present the information provided or encoded by said at least one information source to a user in a readable fashion, or
automatically set the cutting tool in dependence on the information provided or encoded by said at least one information source.

26. A machine tool, comprising:
a cutting tool being assembled and ready for delivery, the cutting tool including at least one actual dimension relating to a physical configuration of the cutting tool and being relevant for a cutting process carried out by the cutting tool, and at least one information source to be read out by a user or a data processing system, said at least one information source providing or encoding information about a deviation of the at least one relevant actual dimension from a target dimension or the actual dimension itself;
a reading device for automatically reading-in information provided or encoded by said at least one information source; and
a holder according to claim 24;
the machine tool configured to at least one of:
present the information provided or encoded by said at least one information source to a user in a readable fashion, or
automatically set said cutting tool in dependence on the information provided or encoded by said at least one information source, or
automatically set said cutting tool for automatically activating said setting device of said holder.

27. The machine tool according to claim 25, wherein said reading device is a barcode reader or a OR code reader.

28. The machine tool according to claim 26, wherein said reading device is a barcode reader or a OR code reader.
